(19) United States
(12) Patent Application Publication
(10) Pub. No.: US 2007/0255547 A1
(43) Pub. Date: Nov. 1, 2007

(54) SOLVING THE PERIODIC STEADY-STATE OPERATING CONDITION OF A PHASE-LOCKED LOOP OR DELAY-LOCKED LOOP CIRCUIT USING A TRANSIENT ESTIMATION METHOD

(75) Inventors: GEORGE ESTEP, BERRYVILLE, VA (US); EDOUARD NGOYA, ISLE (FR); DON WEBBER, SANTA CLARA, CA (US)

Correspondence Address: PATENTRY, P.O. BOX 151616, SAN RAFAEL, CA, 94915-1616, US

(73) Assignee: XPEDION DESIGN SYSTEMS, INC., MILPITAS, CA (US)

(21) Appl. No.: 11/380,774

(22) Filed: Apr. 28, 2006

Related U.S. Application Data
(60) Provisional application No. 60/744,202, filed on Apr. 4, 2006.

(51) Int. Cl. G06F 17/50

(52) U.S. Cl. 703/15

(57) ABSTRACT

A system and method for quickly determining the steady-state condition of a phase-locked loop or a delay-locked loop circuit by simulating a phase-locked loop in DC transient and periodic steady-state analysis and controlling phase and/or delay of the voltage-controlled oscillator and/or reference source, signal, or oscillator.

### CROSS-REFERENCE TO RELATED APPLICATIONS

The present application claims the benefit of priority under 35 USC .sctn. 119(e) from U.S. provisional patent application 60/744,202 filing date Apr. 4, 2005 first named inventor Estep, titled: “Solving the periodic steady-state operating condition of a phase-locked loop or delay-locked loop circuit using a transient estimation method”, which is incorporated in its entirety by reference.

### BACKGROUND OF THE INVENTION

Phase-locked loop (PLL) and delay-locked loop (DLL) circuits have autonomous elements which necessitate extremely long simulation times using conventional methods. After spending days and weeks determining if a single implementation of a phase-locked loop is stable and reliably manufacturable in a semiconductor product, it is apparent to those skilled in the art that what is needed is a system and method for quickly determining the steady-state condition of a phase-locked loop or a delay-locked loop circuit.

### SUMMARY OF THE INVENTION

The present invention comprises a system for quickly determining the steady-state condition of a phase-locked loop (PLL) or delay-locked loop (DLL), the system comprising a direct current (DC) solver, a time-domain solver, a frequency-domain solver, a PLL or a DLL, and at least one of the following: a delay-controlled voltage-controlled oscillator (VCO) trigger, a delay-controlled reference oscillator trigger, a phase- and delay-controlled signal, a phase- and delay-controlled reference source, a phase-controlled reference signal, a delay-controlled reference signal, a delay-controlled reference source, and a phase-controlled reference source.

The present invention further comprises a method for determining a steady-state condition of a phase-locked loop comprising the steps of measuring the phase error and controlling the phase and/or delay of the reference oscillator, signal, or source; and/or controlling the phase and/or delay of the VCO.

### BRIEF DESCRIPTION OF DRAWINGS

FIG. 1 illustrates a general illustration of a PLL with controls over delay and phase.

FIG. 2 illustrates the invention in the case when the VCO may be controlled but not the reference.

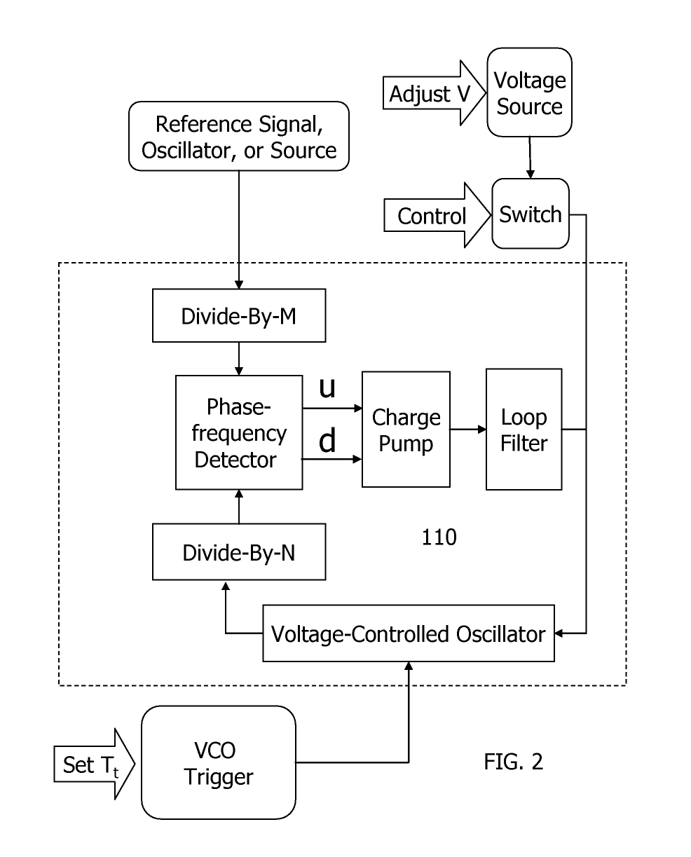

FIG. 3 illustrates the invention in the case when the reference is a source with controllable frequency and phase.

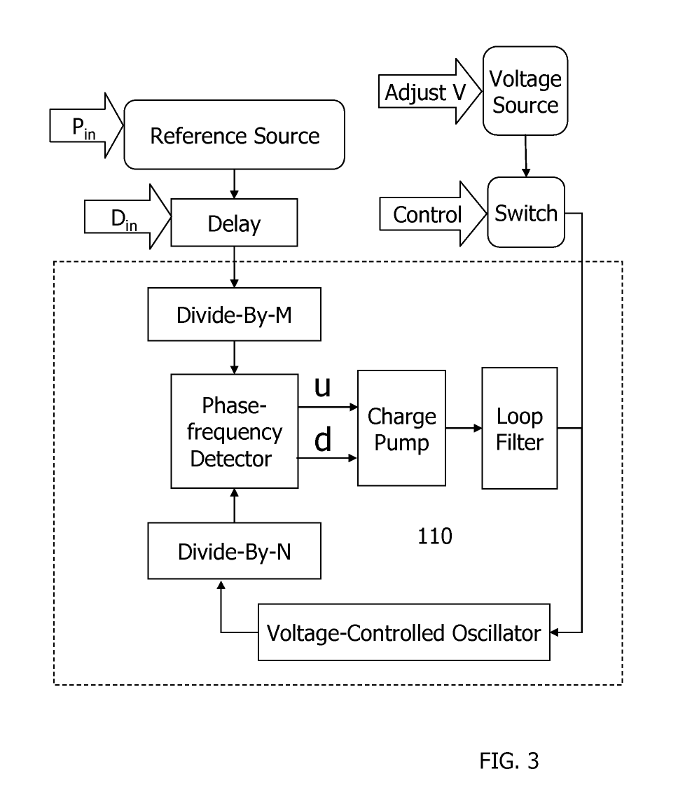

FIG. 4 illustrates the invention in the case when the reference is actual data of a signal.

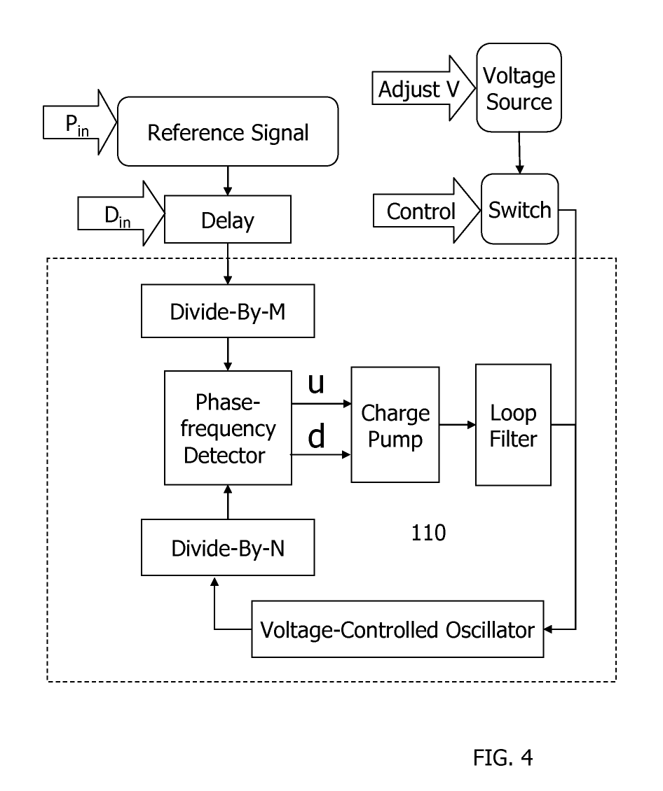

FIG. 5 illustrates the invention in the case when the reference is an oscillator which can be triggered with controllable delay.

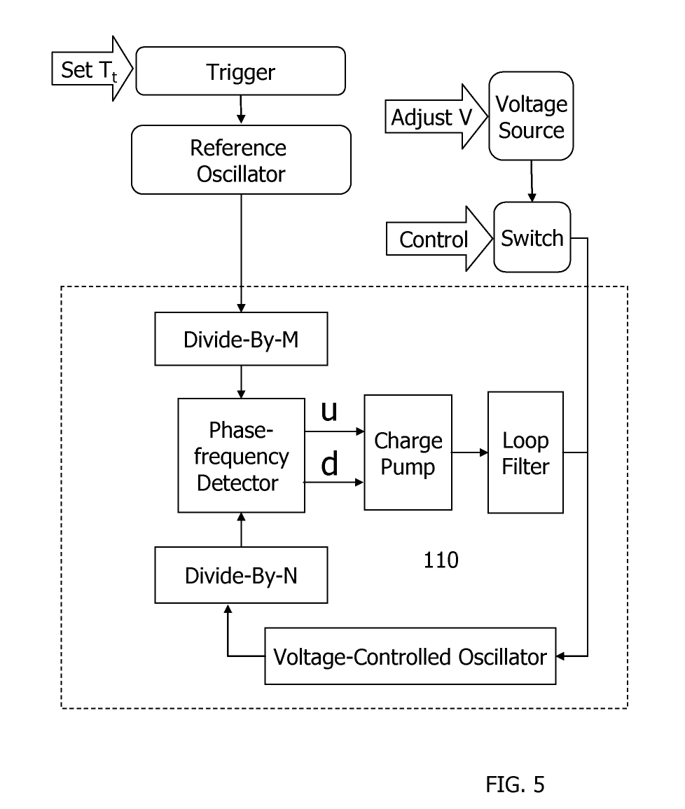

FIG. 6 illustrates the invention in the case when the reference is an oscillator followed by a controllable delay.

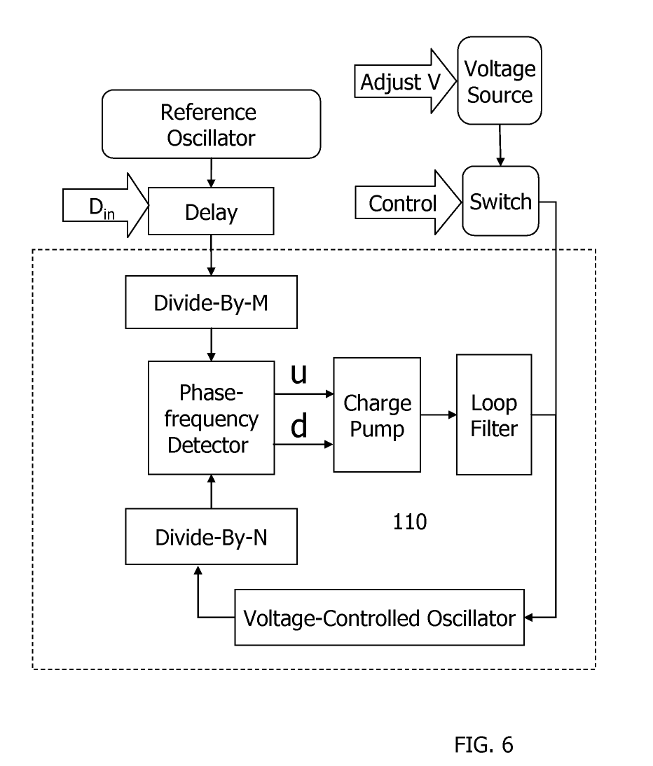

FIG. 7 illustrates the invention in the case when the voltage source and switch can effect a pulse with controllable delay operating on the VCO.

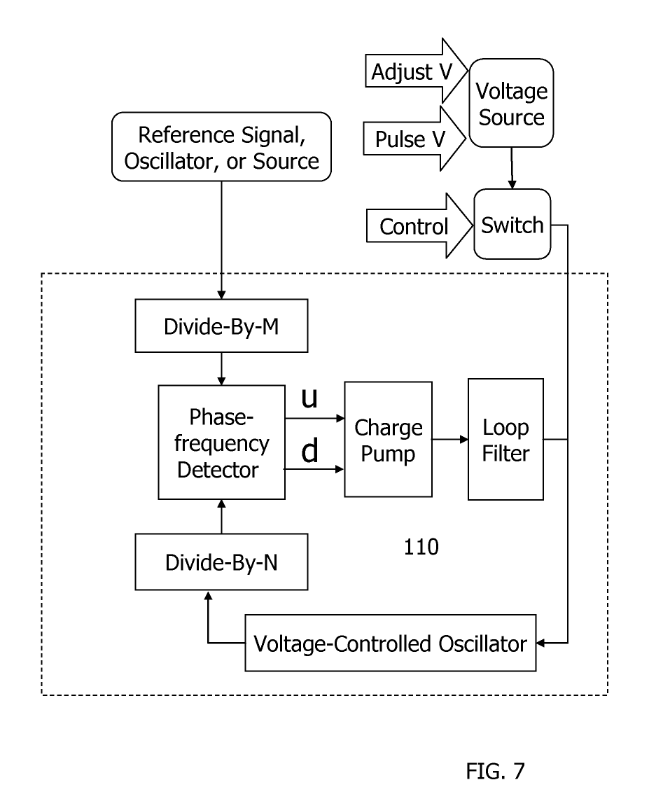

### DETAILED DESCRIPTION

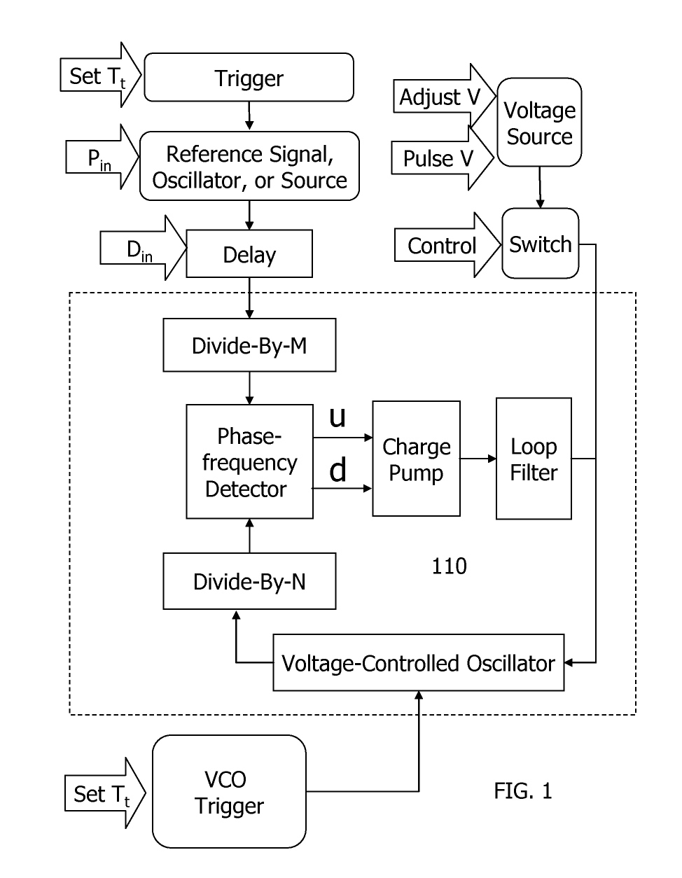

Referring now to FIG. 1, a conventional phase-locked loop (PLL) 110 is coupled through its voltage-controlled oscillator (VCO) to at least one of the following: a VCO trigger controlled by a Set Tt value, and an adjustable voltage source through a controllable switch, and the PLL is further coupled to a reference signal, oscillator, or source through at least one of the following, a wire, a divide-by-m block, a controllable delay block, the reference signal, oscillator or source. In embodiments the reference signal, oscillator, or source having settable phase, delay, and/or triggers in the most general case.

The present invention illustrated in FIG. 1 in a general form. It will be appreciated by those skilled in the art that all elements shown in FIG. 1 are not simultaneously required to practice the invention. Specifically, the general form Divide-By-M and Divide-By-N refers to integers and in the case of M or N or both being 1, the invention is not substantially changed by replacing those blocks by wires. In the general case the VCO may be set to a multiple or a fraction of the reference frequency in which case those skilled in the art will recognize that a conventional phase-locked loop further comprises a Divide-By-M or Divide-By-N or both. The invention further comprises a voltage source coupled to the input of a voltage controlled oscillator through a switch, in an embodiment, a variable resistor.

The invention comprises setting the phase or delay of at least one of the following: a delay-controlled VCO trigger, a delay-controlled reference oscillator trigger, a phase- and delay-controlled signal, a phase- and delay-controlled reference source, a phase-controlled reference signal, a delay-controlled reference signal, a delay-controlled reference source, and a phase-controlled reference source.

The invention comprises at least one of the following: a phase control Pin or a delay control Dn to a reference source, or signal to set the phase or delay of the reference at the beginning of simulation, a delay input to the VCO trigger Set Tt to delay the start of a VCO, a delay input to a trigger coupled to a reference oscillator, and an adjustable voltage source coupled through a controllable switch to trigger the VCO.

The present invention is a method for determining the periodic or quasi-periodic steady-state solution of a non-linear system, the method comprising the steps of adjusting a control voltage of a voltage-controlled oscillator (VCO), correcting relative phase of phase-frequency detector inputs, recording an estimate of a steady-state solution, and solving for a periodic or quasi-periodic steady-state solution of a phase-locked loop or a delay-locked loop.

The method of solving for a periodic or quasi-periodic steady-state solution comprises the steps of setting the initial value of a steady-state simulation to the estimate of steady-state solution recorded during a transient analysis, releasing the control voltage of the VCO if not already released, and performing a periodic or quasi-periodic steady-state solution.

The method of recording an estimate of steady-state conditions comprises the steps of running a transient analysis until observing that feedback and reference signals have propagated back to the input of the voltage controlled oscillator and at least one of the following steps: taking a Fourier Series of the last period of the transient analysis and taking an estimate suitable for use by a periodic steady-state solver.

The method of correcting relative phase of phase-frequency detector inputs comprises the steps of measuring the phase difference between the inputs of a phase-frequency detector and one or more of the following steps: adjusting at least one of the following: the delay of a delay-controlled VCO trigger, the delay of a delay-controlled reference oscillator trigger, the phase and delay of a phase- and delay-controlled signal, the phase and delay of a phase- and delay-controlled reference source, the phase of a phase-controlled reference signal, the delay of a delay-controlled reference signal, the delay of a delay-controlled reference source, the phase of a phase-controlled reference source and pulsing a voltage source further comprising a delay controllable pulse control.

Referring to FIG. 1, the process of adjusting a control voltage of a voltage controlled oscillator (VCO) comprises the following sequence of steps,
1, estimating a control voltage that will drive the VCO to a frequency such that the period of the output of the Divide-By-N matches the period of the output of the Divide-By-M,
2, running a DC simulation,
3, running a transient simulation, and
4, measuring the period of the input to the phase-frequency detector and repeating the sequence with other estimates of a control voltage until period matches the desired period.

In an embodiment, the present invention comprises a VCO with a delay-controlled trigger, and a phase-locked loop, the phase-locked loop in an embodiment further comprising a voltage-controlled oscillator (VCO) coupled to a loop filter, coupled to a charge pump, coupled to a phase-frequency detector which receives and compares two inputs. In an embodiment the two inputs to the phase-frequency detector result from Divide-By-M and Divide-By-N operations. The values of M and N depend on the application of the Phase-locked Loop (PLL). In a degenerative case one or both may have the value of one and the blocks dispensed with. In an embodiment, the present invention comprises a VCO with a delay-controlled trigger, and a delay-locked loop, the delay-locked loop in an embodiment further comprising a voltage-controlled oscillator (VCO) coupled to a loop filter, coupled to a charge pump, coupled to a delay-frequency detector which receives and compares two inputs. In an embodiment the two inputs to the delay-frequency detector result from Divide-By-M and Divide-By-N operations. The values of M and N depend on the application of the delay-locked loop (DLL). In a degenerative case either or both may have the value of one and the blocks dispensed with.

In a conventional phase-locked loop, the two inputs to the phase-frequency detector determine a phase error value which affects a voltage applied to the voltage-controlled oscillator. In a conventional delay-locked loop, the two inputs to the delay-frequency detector determine a delay error value which affects a voltage applied to the voltage-controlled oscillator.

The present invention comprises the step of triggering the voltage-controlled oscillator in a subsequent simulation, in an embodiment, controlling the delay of the trigger.

The present invention is a method for adjusting phase error at the inputs of a phase-frequency detector comprising the steps of measuring phase error during a first simulation and advancing or retarding a delay-controlled VCO trigger applied to a second simulation. The present invention is a method for adjusting phase error at the inputs of a phase-frequency detector comprising the steps of measuring phase error during a first simulation and advancing or retarding the phase control of at least one of the following: a reference oscillator, a reference signal, or a reference source. The present invention is a method for adjusting phase error at the inputs of a phase-frequency detector comprising the steps of measuring phase error during a first simulation and one or more of the following steps: advancing or retarding a delay-controlled VCO trigger applied to a second simulation, advancing or retarding the delay control of at least one of the following: a delay-controlled VCO trigger, a delay-controlled reference oscillator trigger, a phase- and delay-controlled signal, a phase- and delay-controlled reference source, a phase-controlled reference signal, a delay-controlled reference signal, a delay-controlled reference source, and a phase-controlled reference source.

The present invention further comprises the method of driving a voltage-controlled oscillator to a desired frequency the method consisting of the steps of applying a voltage through a switch, in an embodiment the switch being a controllable resistor, and setting the controllable resistor to a high level after the desired frequency has been achieved.

In an embodiment, the method comprises the steps:
setting phase control to a certain time, in an embodiment at or near 0 sec,
running a DC simulation,
running a transient simulation long enough to allow the signals from both the VCO and the reference oscillator/source/signal to pass through both the dividers, if present, and through the phase-frequency detector,
measuring relative phase and/or delay to the inputs of a phase-frequency detector,
correcting the phase or delay at the phase-frequency detector inputs,
rerunning a DC simulation,
rerunning transient simulation analysis long enough to start the dividers,
saving an estimate suitable for periodic or quasi-periodic steady-state solvers,
solving a periodic- or quasi-periodic steady-state condition from the saved estimate, and
recording the steady-state operating condition.

The invention further comprises keeping a voltage-controlled oscillator (VCO near the correct oscillation frequency by adding a structure to force charge-pump voltage within a phase-locked loop, wherein the structure comprises
a voltage source and
a switch.

The method of keeping a VCO near the correct oscillation frequency further comprising the steps of:
setting voltage to a certain VCO input voltage,
setting a switch to conduct (in an embodiment 10 ohms), and
running a transient simulation analysis long enough to start the divider, and
saving operating points for all nodes in the circuit under verification.

An embodiment of the present invention is a computer-readable media such as a carrier or storage media on which is encoded a computer program product having instructions executable by a processor, the instructions comprising: keeping a VCO near the correct oscillation frequency and starting a PLL at proper relative phase, wherein the step of keeping the VCO near the correct oscillation frequency comprises clamping the input voltage of the VCO, and releasing the input voltage of the VCO after the N-divider starts, and wherein clamping is the step of setting a resistance to a low value and releasing is the step of setting a resistance to a high value, and wherein the step of starting a VCO-divider at proper phase comprises applying one of a group of iteratively-selected trigger delay times.

One embodiment of the present invention would be a computer system with input and output devices and a memory unit that stores data files, the data files comprising a circuit description of a phase-locked loop, a DC transient and a periodic simulator, instructions for adapting the operation of a DC transient and periodic simulator; and a processor that is in communication with the memory unit; wherein the processor is programmed to perform the steps following:
setting phase control to 0 sec,
correcting frequency, comprising the steps of
   a. setting voltage to a certain VCO input voltage,
   b. setting injection resistance to a low value,
   c. running DC simulation,
   d. running a transient simulation analysis long enough to start the dividers,
setting phase control to a certain time, in an embodiment at or near 0 sec,
running a DC simulation,
running a transient simulation long enough to allow the signals from both the VCO and the reference oscillator/source/signal to pass through both the dividers, if present, and through the phase-frequency detector,
measuring relative phase and/or delay to the inputs of a phase-frequency detector,
correcting the phase or delay at the phase-frequency detector inputs, comprising at least one of the following steps:
a. adjusting the phase of the reference source,
   b. adjusting the delay of the reference source,
   c. pulsing the voltage source,
   d. advancing or retarding the trigger of the VCO,
   e. advancing or retarding the trigger of a reference oscillator,
rerunning a DC simulation,
rerunning transient simulation analysis long enough to start the dividers,
saving an estimate suitable for periodic or quasi-periodic steady-state solvers,
solving a periodic- or quasi-periodic steady-state condition from the saved estimate, and
recording the steady-state operating condition.

The present invention is a method comprising the steps of keeping a voltage-controlled oscillator (VCO) near the correct oscillation frequency and starting a VCO-divider at proper phase, wherein keeping a VCO near the correct oscillation frequency further comprises the steps of
adding structure to force control voltage within a phase-locked loop, wherein the structure comprises
a voltage source and a switch, and;
starting a VCO-divider at proper phase further comprises the steps of imparting a delay-controlled VCO trigger, the method further comprising the steps of
setting phase control to 0 sec,
setting voltage to a certain VCO input voltage,
setting a switch to conduct,
running a transient simulation analysis long enough to start the divider,
observing phase detector input difference,
adjusting phase control to correct phase detector input difference,
rerunning transient simulation analysis long enough to start the divider,
setting the switch to non-conduct,
running transient analysis restarted from previous transient,
saving fourier series values for all nodes in the circuit under verification,
running periodic steady-state solver starting from fourier series as estimate, and
recording steady-state operating condition.

The present invention further comprises triggers which may act on a reference oscillator or a voltage-controlled oscillator to impart energy with settable delay as described below:

1) A pulsed current source that begins and ends at 0 A can be used to inject energy into a single node in the circuit without disturbing it at any prior or later time. The shape and size of the waveform used is completely arbitrary, as long as it has a controllable beginning time before which the current is 0 A and some later end time after which the current is 0 A.

2) A pulsed voltage source that begins and ends at 0 V can be placed in series with a wire and used to inject energy into the circuit without disturbing it at any prior or later time. The shape and size of the waveform used is completely arbitrary, as long as it has a controllable beginning time before which the voltage is 0 V and some later end time after which the voltage is 0 V.

3) A simulation technique can be used which triggers the circuit condition at a particular time by changing slightly one or more of the node voltages and/or terminal currents. This could be accomplished during the course of a transient simulation or by stopping the simulation, saving the condition at the last point, modifying the saved condition and restarting from the modified condition.

4) Any or all of the included voltage or current sources can have a step applied to them. For instance, any or all of the sources can be run at a slightly different voltage or current initially and then changed to their proper voltage or current at the appropriate time of triggering. This can be done with any positive or negative source or any source at/near 0 V or 0 A.

5) Any or all of the included voltage or current sources can have a pulse applied to them. The shape and size of the waveform used is completely arbitrary, as long as it has a controllable beginning time before which the voltage or current is the desired one and some later end time after which the voltage or current is the desired one. This can be done with any positive or negative source or any source at/near 0 V or 0 A.

6) The voltage source which is used to control the VCO frequency at startup can be pulsed up or down. The shape and size of the waveform used is completely arbitrary, as long as it has a controllable beginning time before which the voltage is set to the appropriate voltage and some later end time after which the voltage is returned to the appropriate voltage. The voltage source further comprising a delay controllable pulse control.

7) The parameter of a component or multiple components, such as resistors, capacitors, inductors, switches or controlled sources which affect oscillation could be pulsed to another value at the appropriate time of triggering. The shape and size of the change of parameter used is completely arbitrary, as long as it has a controllable beginning time before which the value is the desired one and some later end time after which the value is returned to the desired one.

8) The parameter of a component or multiple components, such as resistors, capacitors, inductors, switches or controlled sources which affect oscillation could be stepped to another value at the appropriate time of triggering. For instance, the simulation can be started with the parameters of one or more components at a slightly offset value and then changed to their proper value at the appropriate time of triggering.

### CONCLUSION

The present invention comprises an apparatus for solving the periodic steady-state characteristics of a non-linear periodic or quasi-periodic system comprising a phase-locked loop or a delay-locked loop and at least one of the following: a delay-controlled VCO trigger, a delay-controlled reference oscillator trigger, a phase- and delay-controlled signal, a phase- and delay-controlled reference source, a phase-controlled reference signal, a delay-controlled reference signal, a delay-controlled reference source, a phase-controlled reference source and a voltage source further comprising a delay controllable pulse control.

The present invention further comprises a program product comprising instructions for adapting the operation of a DC transient and periodic or quasi-periodic steady-state simulator, and directing a computer processor to perform the steps modeling the apparatus.

The present invention is a method, comprising the steps of adjusting a control voltage of a voltage-controlled oscillator (VCO), correcting relative phase of phase-frequency detector inputs, recording an estimate of a steady-state solution, and solving for a periodic or quasi-periodic steady-state solution of a phase-locked loop or a delay-locked loop.

One skilled in the art will appreciate that the present invention can be practiced by other than the described embodiments, which are presented for purpose of illustration and not of limitation.

What is claimed is:

1. A method so as to cause a simulator to compute a solution of a non-linear system, the method comprising:
adjusting a control voltage of a voltage-controlled oscillator (VCO) in a first simulation,
correcting relative phase of phase-frequency detector inputs,
recording an estimate of a steady-state solution in a second simulation, and
solving for a solution of a non-linear system.

2. The method of claim 1 wherein the non-linear system is at least one of a phase-locked loop circuit model in a simulator and a delay-locked loop circuit model in a simulator and wherein the solution is one of a periodic steady-state condition and a quasi-periodic steady-state condition.

3. The method of claim 1, wherein solving for the solution comprises the steps of setting an initial value of a steady-state simulation to an estimate of a steady-state solution recorded during a transient analysis, releasing a control voltage of the VCO if not already released, and performing a steady-state solution.

4. The method of claim 1, wherein recording the estimate of a steady-state solution comprises the steps of running a transient analysis until observing that feedback and reference signals have propagated back to an input of the VCO and at least one of taking a Fourier Series of a last period of the transient analysis and taking an estimate for a periodic steady-state solver.

5. The method of claim 1, wherein adjusting a control voltage of a voltage-controlled oscillator (VCO) comprises
1, estimating a control voltage that will drive a VCO to a frequency such that a period of an output of a Divide-By-N circuit matches a period of the output of a Divide-By-M circuit,
2, running a DC simulation of a design under simulation,
3, running a transient simulation of a design under simulation, and
4, measuring periods of inputs to a phase-frequency detector; and
repeating steps 1 through 4 with other estimates of the control voltage until the input periods match.

6. The method of claim 1, wherein correcting relative phase of phase-frequency detector inputs comprises the steps of measuring a phase difference between inputs of a phase-frequency detector and adjusting a delay of a delay-controlled VCO trigger.

7. The method of claim 6, further comprising operating at least one trigger so as to impart energy with settable delay, the trigger comprising a pulsed current source that begins at less than 0.1 A and ends at less than 0.1 A so as to inject energy into a node in a circuit under simulation.

8. The method of claim 1, wherein correcting relative phase of phase-frequency detector inputs comprises the steps of measuring a phase difference between inputs of a phase-frequency detector and adjusting at least one of a delay of a delay-controlled VCO trigger, a delay of a delay-controlled reference oscillator trigger, a phase and a delay of a phase- and delay-controlled signal, a phase and a delay of a phase- and delay-controlled reference source, a phase of a phase-controlled reference signal, a delay of a delay-controlled reference signal, a delay of a delay-controlled reference source, a phase of a phase-controlled reference source, and pulsing a voltage source further comprising a delay controllable pulse control.

9. The method of claim 8, further comprising operating at least one trigger so as to impart energy with settable delay, the trigger comprising a pulsed voltage source that begins at less than 0.1 V and ends at less than 0.1 V placed in series with a wire so as to inject energy into the circuit under simulation.

10. The method of claim 8, further comprising operating at least one trigger so as to impart energy with settable delay, the trigger comprising a simulation technique which triggers the circuit condition at a particular time by changing slightly at least one of the variables, the variables selected from node voltages and terminal currents, comprising the steps of stopping the simulation, saving the condition at the last point, modifying the saved condition and restarting from the modified condition.

11. The method of claim 8, further comprising operating at least one trigger so as to impart energy with settable delay, the trigger comprising a step applied to at least one of the included voltage sources and current sources changing a slightly different value initially set, to their proper value at the appropriate time of triggering wherein the source comprises at least one of the following: a positive source, a negative source, a source at 0 V, a source near 0 V, a source at 0 A, and a source near 0 A.

12. The method of claim 8, further comprising operating at least one trigger so as to impart energy with settable delay, the trigger comprising a pulse applied to at least one of the included voltage sources and current sources wherein the pulse comprises a waveform with a controllable beginning time and wherein the source comprises at least one of the following: a positive source, a negative source, a source at 0 V, a source near 0 V, a source at 0 A, and a source near 0 A.

13. The method of claim 8, further comprising operating at least one trigger so as to impart energy with settable delay, the trigger comprising
a pulse applied to the voltage source which is used to control the VCO frequency at startup wherein the pulse may be one of a positive waveform, and a negative waveform, the pulse having a controllable beginning time before which the voltage is set to the appropriate voltage and some later end time after which the voltage is returned to the appropriate voltage.

14. The method of claim 8, further comprising operating at least one trigger so as to perturb the circuit with settable delay, the trigger comprising
a change of a parameter of at least one of resistors, capacitors, inductors, switches and controlled sources which affect oscillation to another value at the appropriate time of triggering wherein the change of parameter has a controllable beginning time before which the value is the desired one and some later end time after which the value is returned to the desired one.

15. The method of claim 8, further comprising operating at least one trigger so as to perturb the circuit with settable delay, the trigger comprising
a change of a parameter of at least one of resistors, capacitors, inductors, switches and controlled sources which affect oscillation, the change stepping to another value at the appropriate time of triggering, wherein the simulation can be started with the parameters of one or more components at a slightly offset value and then changed to their proper value at the appropriate time of triggering.

16. A computer program product tangibly embodied on a computer readable medium encoding the method of claim 1 as instructions executable by a processor, the instructions comprising:
adjusting a control voltage of a voltage-controlled oscillator (VCO),
correcting relative phase of phase-frequency detector inputs,
recording an estimate of a steady-state solution, and
solving for a periodic or quasi-periodic steady-state solution of a non-linear system.

17. The computer program product as recited in claim 16, wherein adjusting a control voltage of a voltage-controlled oscillator (VCO) comprises the following sequence of steps:
1, estimating a control voltage that will drive a VCO to a frequency such that the period of the output of a Divide-By-N circuit matches the period of the output of a Divide-By-M circuit,
2, running a DC simulation,
3, running a transient simulation, and
4, measuring periods of the inputs to the phase-frequency detector; and
repeating the sequence with other estimates of a control voltage until the periods of the inputs match.

18. The computer program product as recited in claim 16, wherein the method of correcting the relative phase of phase-frequency detector inputs comprises of adjusting the delay of a trigger, whereby the trigger may act on at least one of a reference oscillator and a voltage-controlled oscillator to impart energy with settable delay, the trigger comprising a pulse applied to the voltage source which is used to control the VCO frequency at startup wherein the pulse may be a positive or negative waveform, wherein the shape and size of the waveform used is completely arbitrary, as long as it has a controllable beginning time before which the voltage is set to the appropriate voltage and some later end time after which the voltage is returned to the appropriate voltage.

19. A system for determining the periodic or quasi-periodic steady-state solution of a non-linear system, comprising:
a memory unit that accesses stored data files, the data files comprising typical model parameters for a phase-locked loop or delay-locked loop circuit, and
a processor that is in communication with the memory unit;
wherein the processor is adapted to perform the steps following:
adjusting a control voltage of a voltage-controlled oscillator (VCO),
correcting relative phase of phase-frequency detector inputs,
recording an estimate of a steady-state solution, and
solving for a periodic or quasi-periodic steady-state solution of a non-linear system.

20. The system as recited in claim 19, further comprising an input device for controlling the processor and further comprising a display device for viewing processing results of the processor.

21. A system and method for quickly determining the steady-state condition of a phase-locked loop or a delay-locked loop circuit comprising:
a memory unit that stores data files, the data files comprising a circuit description of a phase-locked loop, a DC transient and periodic steady-state solver, instructions for adapting the operation of a DC transient and periodic steady-state solver;
and a processor that is in communication with the memory unit;
wherein the processor is programmed to perform the method comprising:
a method of adjusting a control voltage of a voltage controlled oscillator;
comprising estimating the desired voltage of the VCO, running a DC simulation, running a transient simulation, and measuring the frequency and repeating these steps until the frequency of the VCO matches the frequency of the reference,
a method of correcting relative phase of comparator inputs;
comprising measuring phase differences at the inputs of the comparator and at least one of the following steps:
adjusting delay of a VCO by applying a delayed trigger,
adjusting delay of a VCO by adjusting its voltage source and switch,
adjusting delay of a reference waveform,
adjusting delay of a reference oscillator, and
adjusting delay of a reference source;
a method of recording an estimate of steady-state conditions;
comprising the steps of running transient analysis simulation until the VCO receives feed back from the loop filter and at least one of the following: taking a Fourier Series of the last period or recording the Shooting Newton Estimate; and
a method of solving for periodic steady-state characteristics, comprising the steps of setting the initial state to the recorded estimate of steady-state, checking that the control voltage of the VCO has been released, and running periodic steady-state analysis simulation.

22. The system as recited in claim 21, further comprising an input device for controlling the processor and a display device for viewing processing results of the processor.

23. A program product tangibly embodied in a computer readable medium adapted to direct a processor to perform the following steps:
setting phase control to 0 sec,
correcting frequency, comprising the steps of
a. setting voltage to a certain VCO input voltage,
b. setting injection resistance to a low value,
c. running DC simulation,
d. running a transient simulation analysis long enough to start the dividers,
setting phase control to a certain time, in an embodiment at or near 0 sec,
running a DC simulation,
running a transient simulation long enough to allow the signals from both the VCO and the reference oscillator/source/signal to pass through both the dividers, if present, and through the phase-frequency detector,
measuring relative phase and/or delay to the inputs of a phase-frequency detector,
correcting the phase or delay at the phase-frequency detector inputs, comprising at least one of the following steps:
a. adjusting the phase of the reference source,
b. adjusting the delay of the reference source,
c. pulsing the voltage source,
d. advancing or retarding the trigger of the VCO,
e. advancing or retarding the trigger of a reference oscillator,
rerunning a DC simulation,
rerunning transient simulation analysis long enough to start the dividers,
saving an estimate suitable for periodic or quasi-periodic steady-state solvers,
solving a periodic- or quasi-periodic steady-state condition from the saved estimate, and
recording the steady-state operating condition.
